(19) United States
(12) Patent Application Publication
(10) Pub. No.: US 2023/0141178 A1
(43) Pub. Date: May 11, 2023

(54) INFORMATION PROCESSING DEVICE, GENERATION METHOD, AND PROGRAM

(71) Applicant: SONY GROUP CORPORATION, Tokyo (JP)

(72) Inventor: Hiroyoshi FUJII, Tokyo (JP)

(73) Assignee: SONY GROUP CORPORATION, Tokyo (JP)

(21) Appl. No.: 17/916,717

(22) PCT Filed: May 7, 2021
(86) PCT No.: PCT/JP2021/017535

§ 371 Date: Oct. 3, 2022

(30) Foreign Application Priority Data
May 21, 2020 (JP) 2020-088839

(51) Int. Cl. G09B 5/06; H04N 5/77; H04N 5/92; G11B 27/02; G06Q 50/20

(52) U.S. Cl. CPC G09B 5/065; H04N 5/77; H04N 5/92; G11B 27/02; G06Q 50/20

(57) ABSTRACT

There is provided an information processing device, a generation method, and a program that are capable of editing or reproducing a lecture-containing video in an appropriate form. The information processing device includes a generation unit configured to generate information for reproduction assistance, depending on importance levels each determined for one of predetermined sections generated by dividing data including a video and a sound of a lecture. The importance levels are determined on the basis of information associated with the lecture. The present technology can be applied to, for example, a lecture capture system used for imaging a lecture.

### TECHNICAL FIELD

The present technology relates to an information processing device, a generation method, and a program, and particularly relates to an information processing device, a generation method, and a program that are capable of editing or reproducing a lecture-containing video in an appropriate form.

### BACKGROUND ART

In recent years, opportunities to record lectures have been increasing in the field of education. In the case of recording a lecture-containing video, it is required that the lecture-containing video is effectively recorded by performing editing, for example, deleting a section, of the video for the entire lecture time, not important for learning.

For example, Patent Document 1 describes a technique in which an importance level is evaluated on the basis of the following items in each section of a video divided on the basis of the speech time of a predetermined person: the number of times of speaking; the number of participants in a discussion; a discussion time; a volume; a gesture; an emotion; and the like, and in which sections having a low importance level are edited

### CITATION LIST

### Patent Document

Patent Document 1: Japanese Patent Application Laid-Open No. 2016-46705

### SUMMARY OF THE INVENTION

### Problems to be Solved by the Invention

In a case where the technique described in Patent Document 1 is applied to editing of a lecture-containing video, importance level determination is performed on the basis of information linked to a person such as a speech time, a volume, a gesture, and an emotion of a teacher. In a case where a lecture-containing video is edited depending on the importance level determined as described above, there is a possibility that the importance level of a section of the video in which the teacher is performing board writing is determined to be low and that the information on in what order the board writing was being performed is lost from the lecture-containing video, even though such order is considered to be important in learning.

The present technology has been made in view of such a situation, and enables editing or reproducing a lecture-containing video in an appropriate form.

### SOLUTION TO PROBLEMS

An information processing device of one aspect of the present technology includes a generation unit configured to generate information for reproduction assistance, depending on importance levels each determined for one of predetermined sections generated by dividing data including a video and a sound of a lecture, the importance levels being determined on the basis of information associated with the lecture.

A generation method of one aspect of the present technology includes generating information for reproduction assistance, depending on importance levels each determined for one of predetermined sections generated by dividing data including a video and a sound of a lecture, the importance levels being determined on the basis of information associated with the lecture.

A program, of one aspect of the present technology, for causing a computer to perform a process includes generating information for reproduction assistance, depending on importance levels each determined for one of predetermined sections generated by dividing data including a video and a sound of a lecture, the importance levels being determined on the basis of information associated with the lecture.

In one aspect of the present technology, information for reproduction assistance is generated, depending on importance levels each determined for one of predetermined sections generated by dividing data including a video and a sound of a lecture, the importance levels being determined on the basis of information associated with the lecture.

### BRIEF DESCRIPTION OF DRAWINGS

FIG. 1 is a diagram illustrating an appearance of an imaging system according to one embodiment of the present technology. FIG. 2 is a block diagram illustrating a configuration example of the imaging system.

FIG. 3 is a block diagram illustrating a functional configuration example of an arithmetic device.

FIG. 4 is a diagram illustrating an example of importance level determination rules.

FIG. 5 is a diagram illustrating an example of editing rules.

FIG. 6 is a diagram illustrating an example of a timeline of a lecture-containing video.

FIG. 7 is a diagram illustrating an example of a timeline of a lecture-containing video.

FIG. 8 is a diagram illustrating an example of a timeline of a lecture-containing video.

FIG. 9 is a diagram illustrating an example of importance level determination rules.

FIG. 10 is a diagram illustrating an example of the importance levels of respective pieces of analysis information determined for each determination section.

FIG. 11 is a diagram illustrating an example of a timeline of edited video data.

FIG. 12 is a flowchart illustrating a process performed by the arithmetic device.

FIG. 13 is a diagram illustrating the relationship between a temporal change in a board writing amount and an importance level.

FIG. 14 is a block diagram illustrating a configuration example of hardware of a computer.

### MODE FOR CARRYING OUT THE INVENTION

Hereinafter, modes for carrying out the present technology will be described. The description will be given in the following order.

1. Configuration of imaging system according to one embodiment of present technology

2. Example of editing of video data

3. Operation of arithmetic device

4. Modified example

5. Computer

### 1. Configuration of Imaging System According to One Embodiment of Present Technology

Configuration Example of Imaging System

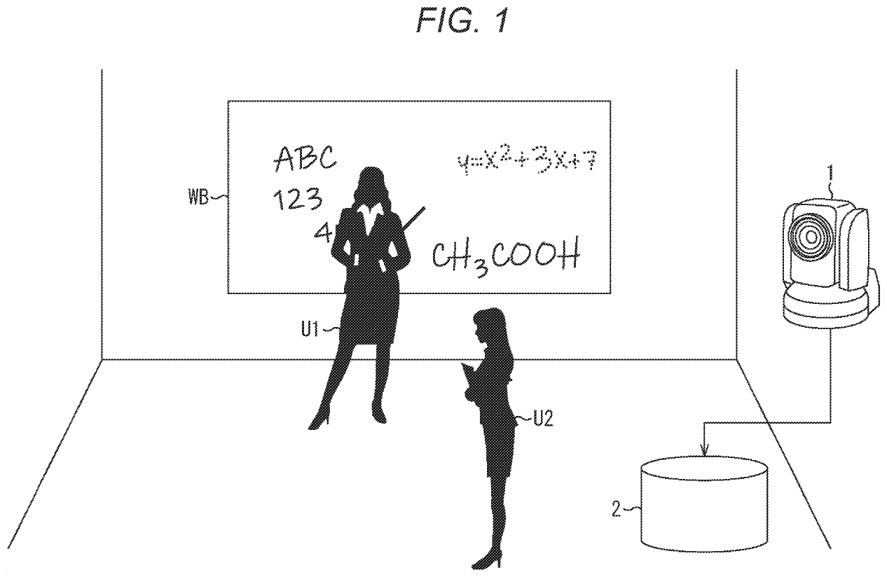

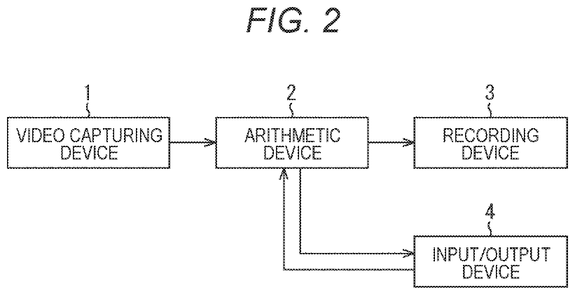

FIG. 1 is a diagram illustrating an appearance of an imaging system according to one embodiment of the present technology.

The imaging system is configured as a lecture capture system, and is installed in a classroom or an auditorium where a teacher U1 gives a lecture to a student U2.

FIG. 1 illustrates a scene in which a student (auditor) U2 attends a lecture given by a teacher (lecturer) U1 using a whiteboard WB in a classroom (lecture room).

The teacher U1 is a person who is giving a lecture, and the teacher U1 describes the lecture while performing board writing on the whiteboard WB during the lecture.

On the whiteboard WB, a board writing is written and deleted depending on the description of the lecture. For the board writing, not only one color is used, but a plurality of colors is used. With reference to FIG. 1, the characters depicted by solid lines on a board surface of the whiteboard WB represent characters written with a black color pen (pen with black ink), and the characters depicted by dotted lines represent characters written with a red color pen (pen with red ink).

The student U2 a person attending the lecture, and makes a statement during the lecture and steps forward to perform board writing. Note that a lecture may be imaged in a place such as a dedicated studio where there is no student U2. Alternatively, a lecture may be imaged when a plurality of students is auditing the lecture in a classroom.

A video capturing device 1 is installed in a lecture room and performs imaging at such art angle of view that the teacher U1 and the whiteboard WB can be imaged. Video data containing a video signal representing the captured video and a sound signal is output to an arithmetic device 2.

The arithmetic device 2 receives the video data supplied from the video capturing device 1, and performs importance level determination on the basis of the video signal and the sound signal. The arithmetic device 2 edits the video data on the basis of the result of the importance level determination.

FIG. 2 is a block diagram illustrating a configuration example of the imaging system.

The imaging system of FIG. 2 includes the video capturing device 1, the arithmetic device 2, a recording device 3, and an input/output device 4.

The video capturing device 1 is configured as, for example, a camera that performs imaging at such an angle of view that the teacher U1 and the whiteboard WB can be simultaneously imaged. The video data representing the captured video is output to the arithmetic device 2. Not only a single video capturing device 1 but also a plurality of video capturing devices 1 may be provided.

The arithmetic device 2 is configured as an information processing device that receives the video data supplied from the video capturing device 1 and performs importance level determination on the basis of the video data. The arithmetic device 2 is connected to the video capturing device 1 by wired or wireless communication. The arithmetic device 2 edits the video data on the basis of the result of the importance level determination, and outputs the edited video data to the recording device 3 and the input/output device 4.

The arithmetic device 2 may include pieces of dedicated hardware having their respective functions, or may include a general computer, and the functions may be realised by software. Furthermore, the arithmetic device 2 and the video capturing device 1 do not have to be configured as independent devices, and may be integral configured as a single device.

The recording device 3 records the video data supplied from the arithmetic device 2. The recording device 3 and the arithmetic device 2 do not have to be configured as independent devices, and may be integrally configured as a single device. Furthermore, the recording device 3 may be connected to the arithmetic device 2 via a network.

The input/output device 4 includes: a keyboard and a mouse that receive a user's operation; a display having a display function; a speaker having a sound output function; and the like. The display having a display function may be provided with a touch panel function.

The input/output device 4 receives an instruction based on a user's operation, and outputs, to the arithmetic device, 2 a rule signal representing the instruction given by the user. For example, the user instructs the following rules: importance level determination rules representing on the basis of what kind of information the importance level determination is performed; and editing rules representing what kind of editing is performed on the basis of the result of the importance level determination.

In addition, the input/output device 4 presents, to the user, data including the video signal and the sound signal supplied from the arithmetic device 2.

The input/output device 4 and the arithmetic device 2 do not have to be configured as independent devices, and may be integrally configured as a single device. Furthermore, the input/output device 4 may be connected to the arithmetic device 2 via a network.
Functional Configuration Example of Arithmetic Device

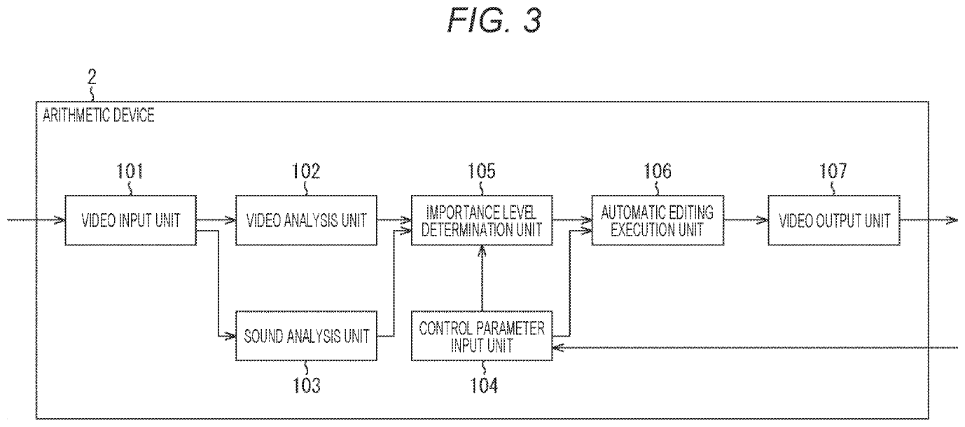

FIG. 3 is a block diagram illustrating a functional configuration example of the arithmetic device 2.

The arithmetic device 2 in FIG. 3 includes a video input unit 101, a video analysis unit 102, a sound analysis unit 103, a control parameter input unit 104, an importance level determination unit 105, an automatic editing execution unit 106, and a video output unit 107.

The video input unit 101 receives at least one piece of video data supplied from the video capturing device 1. As described above, the video data includes a video signal and a sound signal. The video input unit 101 supplies the video signal representing the video captured by the video capturing device 1 to the video analysis unit 102, and outputs the sound signal representing the voice collected in the lecture room to the sound analysis unit 103.

The video analysis unit 102 analyzes at least one type of video information (information representing a video related to a lecture) on the basis of the video signal supplied from the video input unit 101. For example, the video analysis unit 102 analyzes, as the video information, information regarding a teacher's behavior, a student's behavior, a content of a board writing, an increase or decrease amount of characters of a board writing, a color of characters of a board writing, a material attached to a whiteboard, and the like.

The video analysis unit 102 outputs an analysis result of the video information and the video signal to the importance level determination unit 105.

The sound analysis unit 103 analyzes at least one type of sound information (information representing a sound related to a lecture) on the basis of the sound signal supplied from the video input unit 101. For example, information regarding the teacher's voice, the student's voice, and a chime sound is analyzed as the sound information by the sound analysis unit 103. Note that, hereinafter, in a case where it is not necessary to separately deal with the video information and the sound information, the video information and the sound information are collectively referred to as analysis information.

The sound analysis unit 103 outputs an analysis result of the sound information and the sound signal to the importance level determination unit 105.

The control parameter input unit 104 receives a rule signal representing the importance level determination rules and a rule signal representing the editing rules supplied from the input/output device 4.

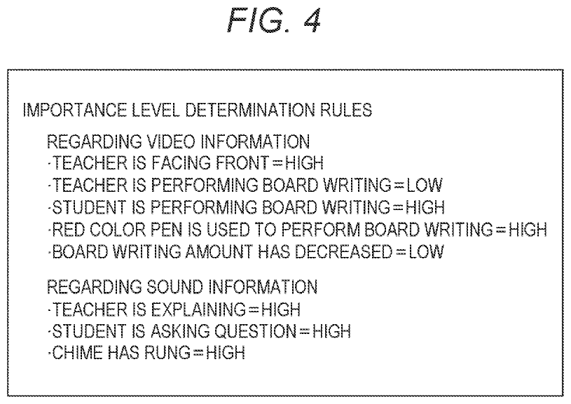

FIG. 4 is a diagram illustrating an example of the importance level determination rules.

As illustrated in FIG. 4, as the importance level determination rules with respect to the video information, the following rules are instructed by the user, for example: “If the teacher is facing front (in the direction of the back of the classroom), the importance level is high”; “If the teacher is performing board writing, the importance level low”; “If the student is per board writing, the importance level is high”; “If board writing is being performed with a red pen (red color pen), the importance level is high”, and “If the board writing amount has decreased, the importance level low”.

Furthermore, as the importance level determination rules with respect to the sound information, the following rules are instructed by the user, for example: “If the teacher is explaining, the importance level is high”; “If the student is asking a question, the importance level is high”; and “If the chime rang, the importance level high”.

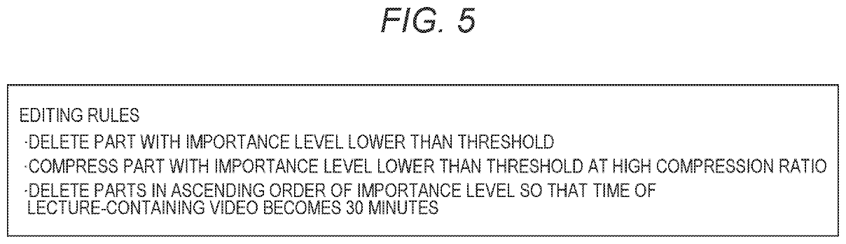

FIG. 5 is a diagram illustrating an example of the editing rules.

As illustrated in FIG. 5, as the editing rules, the following rules are instructed by the user, for example: “Delete a part with an importance level lower than a threshold”; “Compress a part with an importance level lower than a threshold at a high compression ratio”, and “Delete parts in an ascending order of importance level so that a time of the lecture-containing video becomes 30 minutes”.

The control parameter input unit 104 in FIG. 3 outputs the rule signal representing the above-described importance level determination rules to the importance level determination unit 105, and outputs the rule signal representing the editing rules to the automatic editing execution unit 106.

In accordance with the rule signal supplied from the control parameter input unit 104, the importance level determination unit 105 performs importance level determination on the basis of the analysis result of the video information supplied from the video analysis unit 102 and the analysis result of the sound information supplied from the sound analysis unit 103.

The importance level is not determined as a unique value for the entire video; data, but is determined as a value for each of sections obtained by dividing the video data into snort times.

As a method of dividing the video data, various methods can be considered. There are examples as follows: a method of dividing the video data every predetermined time (for example, 5 seconds); a method of dividing the video data on the basis of the voice (for example, sound pressure) of the teacher; a method of recognizing a tip of a pen used for board writing and dividing the video data at a timing when the tip of the pen has been away from the board surface of a whiteboard for a predetermined time; and a method of dividing the video data on the basis of an increase or decrease amount of characters of a board writing. Note that the video data may be divided by a combination of the above division methods.

The importance level determination unit 105 determines the importance level of each section obtained by dividing the video data not by binary values such as important or unimportant, but by values of −1.0 to 1.0, for example.

The importance level may be further determined for a determination section that is a section into which a plurality of consecutive sections with determined. importance levels are combined. In this case, the importance level of the determination section is one of the following value calculated from the importance levels of the sections included in the determination section: an average value, a maximum value, a minimum value, and a weighted sum in accordance with time lengths of the sections.

In a case where the importance level is determined on the basis of the analysis results of a plurality of types of analysis information, one of the following values obtained from the importance levels determined on the basis of the analysis results of each type of the analysis information is used as the final importance level: an average, a maximum value, a minimum value, a sum, a product, and a weighted sum in accordance with weights represented by the rule signal.

Note that the number of sections to be combined into one determination section is, for example, a previously set number of sections. The following number of sections may be combined into one determination section: the number of sections set on the basis of the voice of the teacher; the number of sections set on the basis of the recognition result of the pen tip; and the number of sections set on the basis of the increase or decrease amount of characters of the board writing.

The importance level determination unit 105 outputs the following to the automatic editing execution unit 106: the video data into which the video signal supplied from the video analysis unit 102 and the sound signal supplied from the sound analysis unit 103 are combined; and the result of the importance level determination.

The automatic editing execution unit 106 edits the video data on the basis of the result of the importance level determination determined by the importance level determination unit 105 in accordance with the rule signal supplied from the control parameter input unit 104. The video data edited by the automatic editing execution unit 106 is output to the video output unit 107.

The video output unit 107 outputs the video; data supplied from the automatic editing execution unit 106 to the recording device 3 and the input/output device 4.

### 2. Example of Editing of Video Data

Hereinafter, a description will be given on an example of editing of the video data obtained by recording the lecture in the classroom described with reference to FIG. 1. Here, it is assumed that a 120 minute lecture was given in the classroom of FIG. 1.

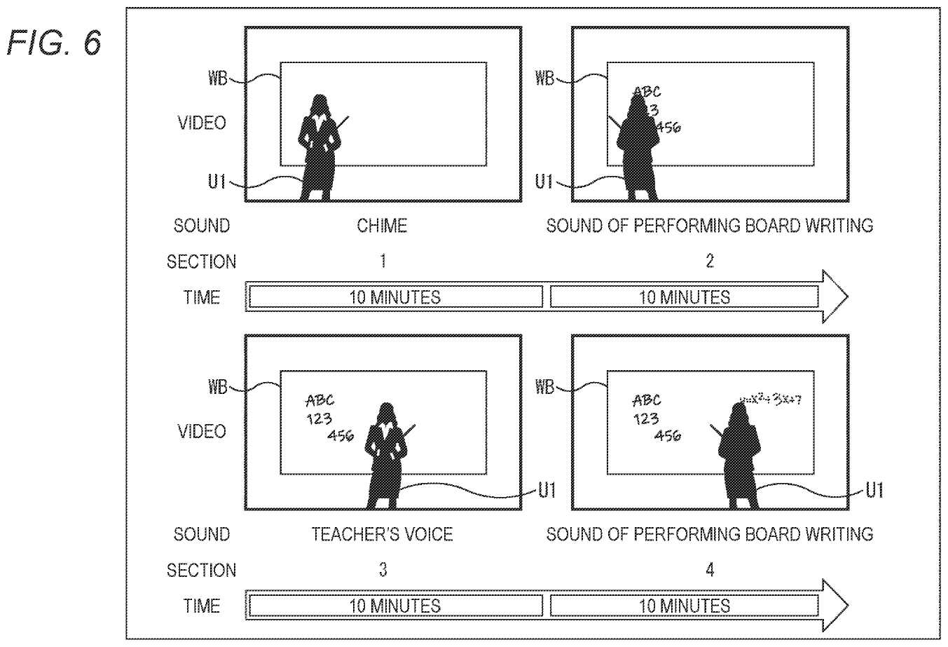

FIGS. 6 to 8 are diagrams illustrating an example of a timeline of the lecture-containing video.

In FIGS. 6 to 8, the video data of the lecture-containing video is divided into 12 determination. sections of determination sections 1 to 12 in chronological order. The determination sections are sections with 10-minute intervals. FIGS. 6 to 8 illustrate characters representing the contents of a representative screenshot and sound in each determination section.

As illustrated in the upper left part of FIG. 6, in the video of a determination section 1 there is imaged the teacher U1 standing in front of the whiteboard WB. No board writing is being performed on the whiteboard WB. As a representative sound in the determination section 1, a chime sound is recorded.

As illustrated in the upper right part of FIG. 6, in the video of a determination section 2 there is imaged the teacher U1 performing board writing on the left side of the whiteboard WB with a black color pen. As the representative sound in the determination section 2, a sound of performing board writing is recorded.

As illustrated the lower left part of FIG. 6, in the video of a determination section 3 there is imaged the teacher U1 explaining the board writing written on the whiteboard WB. As the representative sound in the determination section 3, the voice of the teacher U1 is recorded.

As illustrated in the lower right part of FIG. 6, in the video of a determination section 4 there is imaged the teacher U1 performing board writing on the upper right side of the whiteboard WB with a red color pen. As the representative sound in the determination section 4, the sound of performing board writing is recorded.

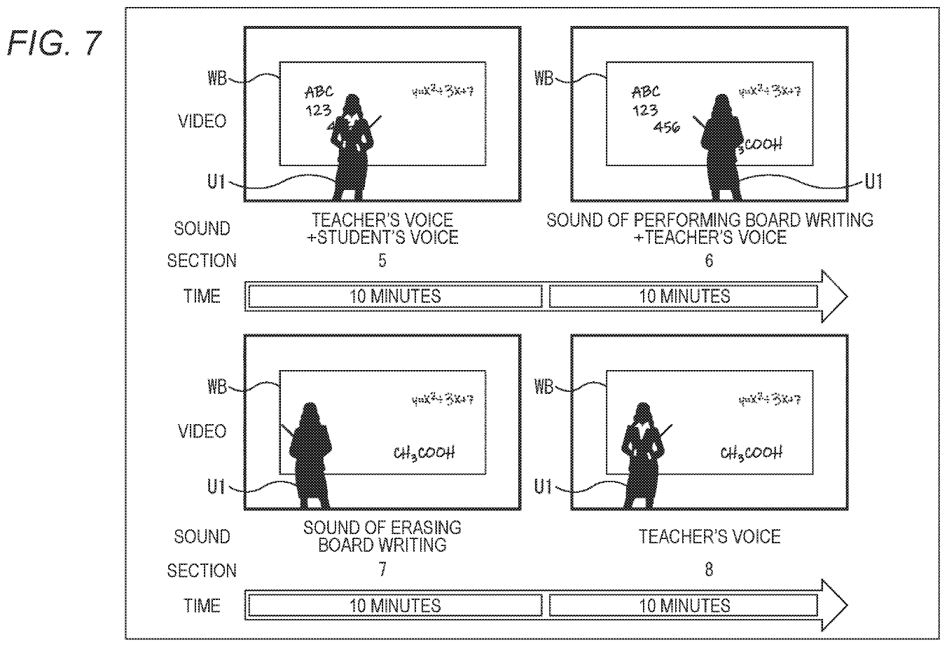

As illustrated in the upper left part of FIG. 7, in the video of a determination section 5 there is imaged the teacher U1 explaining on a question from the student U2. As the representative sound in the determination section 5, the voice of the teacher U1 and the voice of the student U2 asking the question.

As illustrated in the upper right part of FIG. 7 in the video of a determination section 6 there is imaged the teacher U1 explaining while performing board writing on the lower right side of the whiteboard WB with a black color pen. A chemical formula is being written on the whiteboard WB by the teacher U1. As the representative sound in the determination section 6, the sound of performing board writing and the voice of the teacher U1 are recorded.

As illustrated the lower left part of FIG. 7, in the video of a determination section 7 there is imaged the teacher U1 erasing the board writing on the left side of the whiteboard WB. As the representative sound in the determination section 7, a sound of erasing a board writing is recorded.

As illustrated in the lower right part of FIG. 7 in the video of a determination section 8 there is imaged the teacher U1 explaining the lecture. As the representative sound in the determination section 8, the voice of the teacher U1 is recorded.

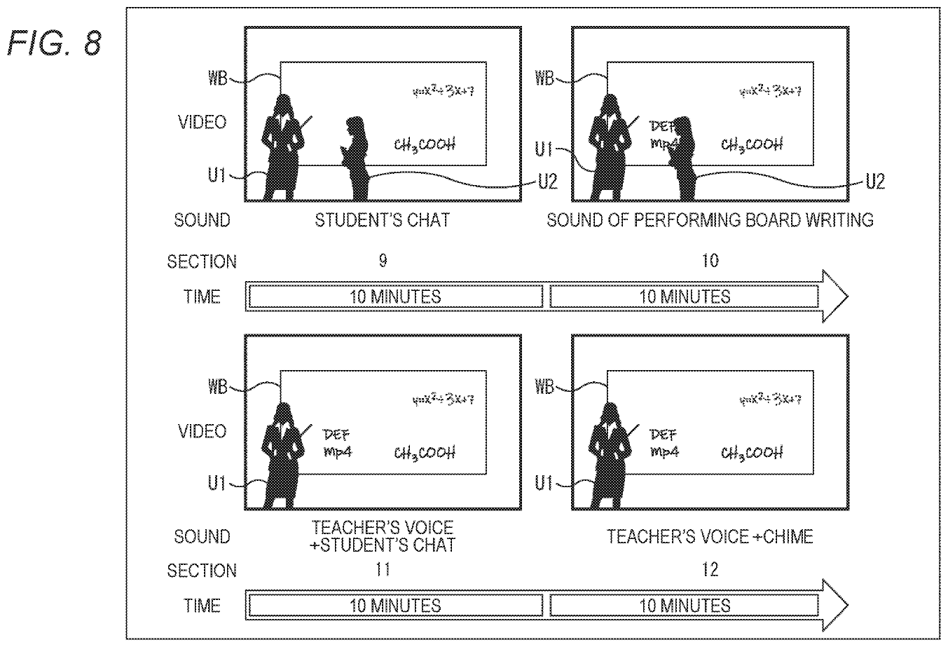

As illustrated in the upper left part of FIG. 8, in the video of a determination section 9 there is imaged, together with the teacher U1 and the whiteboard WB, the student U2 chatting. As the representative sound in the determination section 9, the voice of the student U2 chatting is recorded.

As illustrated in the upper right part of FIG. 8, in the video of a determination section 10 there is imaged the student U2 performing board writing on the lower left side of the whiteboard WB with a black color pen. As the representative sound in the determination section 10, the sound of performing board writing is recorded.

As illustrated in the lower left part of FIG. 8, in the video of a determination section 11 there is imaged the teacher U1 explaining the board writing performed on the whiteboard WB by the student U2. As the representative sound in the determination section 11, the voice of the teacher U1 and the voice of the student U2 chatting.

As illustrated in the lower right part of FIG. 8, in the video of a determination section 12 there is imaged the teacher U1 explaining a summary of the lecture. As the representative sound in the determination section 12, the voice of the teacher U1 and a chime sound are recorded.

The video analysis unit 102 and the sound analysis unit 103 analyze the video information and the sound information for each of the 12 determination sections as described above. Here, as the video information, the following are analyzed: a movement of the teacher; a direction of the teacher's face; a movement of the student; a color of the board writing; an increase or decrease in the board writing amount; and a content of the board writing. In addition, as the sound information, the following are analyzed: a content of the teacher's voice; a volume of the teacher's voice; a tone of the teacher's voice; a question by the student's voice; a chat by the student's voice; a chime; a content sound; and a board writing sound.

Note that the analyses of the video information and the sound information are performed using conventional methods. For example, it is possible to distinguish between a teacher and a student by an image-based individual recognition method or a voiceprint-based individual recognition method, and it is also possible to recognize the content of a board writing by combining a board writing extraction function and an optical character recognition (OCR) method.

The importance level determination unit 105 determines the importance level of each of the 12 determination sections on the basis of the analysis result of the video information and the analysis result of the sound information. Specifically, the importance level determination unit 105 determines the importance level of each piece of an information in each section in accordance with the importance level determination rules. For example, the video data is divided into sections with five-second intervals.

After that, the importance level determination unit 105 combines 120 consecutive sections into one determination section, and determines, as the importance level of the determination section, an average values of the importance levels of the respective pieces of analysis information in each of the 120 sections.

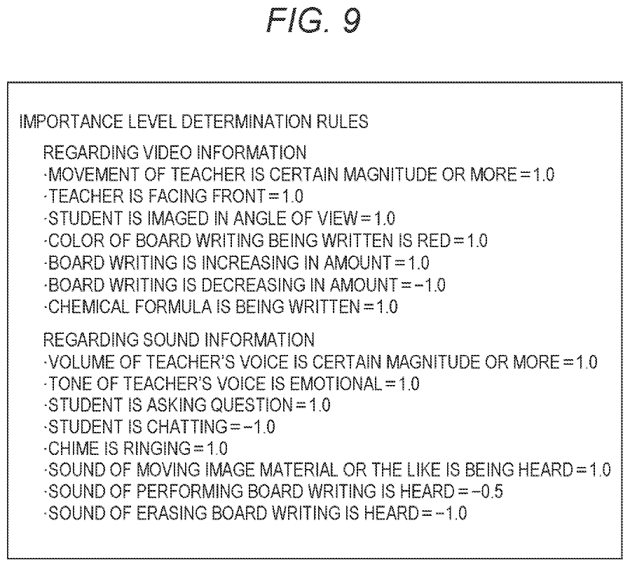

FIG. 9 is a diagram illustrating an example of the importance level determination rules.

As illustrated in FIG. 9, regarding the importance level determination rules with respect to the video information, the importance level determination is performed in accordance with the following rules: “If a movement of the teacher is a certain magnitude or more, the importance level is 1.0” with respect to the movement of the teacher; and “If the teacher is facing front, the importance level is 1.0” with respect she director of the teacher's face.

In addition, regarding the importance level determination rules with respect to the video information, the importance level determination is performed in accordance with the rule of “If the student is imaged in the angle of view, the importance level is 1.0”.

Furthermore, regarding the importance level determination rules with respect to the video information, the importance level determination is performed in accordance with the following rules: “If the color of the board writing being written is red, the importance level is 1.0” with respect to the color of the board writing; “If the board writing is increasing in amount, the importance level is 1.0” and “If the board writing is decreasing in amount, the importance level is −1.0” for the increase or decrease of the board writing; and “If a chemical formula is being written, the importance level is 1.0” for the content of the board writing.

Regarding the importance level determination rules with respect to the sound information, the importance level determination is performed in accordance with the following rules: “If the volume of the teacher's voice is a certain magnitude or more, the importance level is 1.0” with respect to the volume of the teacher's voice; and “If the tone of the teacher's voice is emotional, the importance level is 1.0” with respect to the tone of the teacher's voice.

In addition, regarding the importance level determination rules with respect to the sound information, the importance level determination is performed in accordance with the following rules: “If the student is asking a question, the importance level is 1.0” with respect to a question by a student's voice; and “If the student is chatting, the importance level is −1.0.” with respect to the student's voice.

Furthermore, regarding the importance level determination rules with respect to the sound information, the importance level determination is performed in accordance with the following rules: “If a chime is ringing, the importance level is 1.0” with respect to the chime; “If a sound of a moving image material or the like (content) is sounding, the importance level is 1.0” with respect to the content; and “If the sound of performing board writing sounds, the importance level is −0.5” and “If the sound of erasing the board writing sounds, the importance level is −1.0” with respect to the board writing sound.

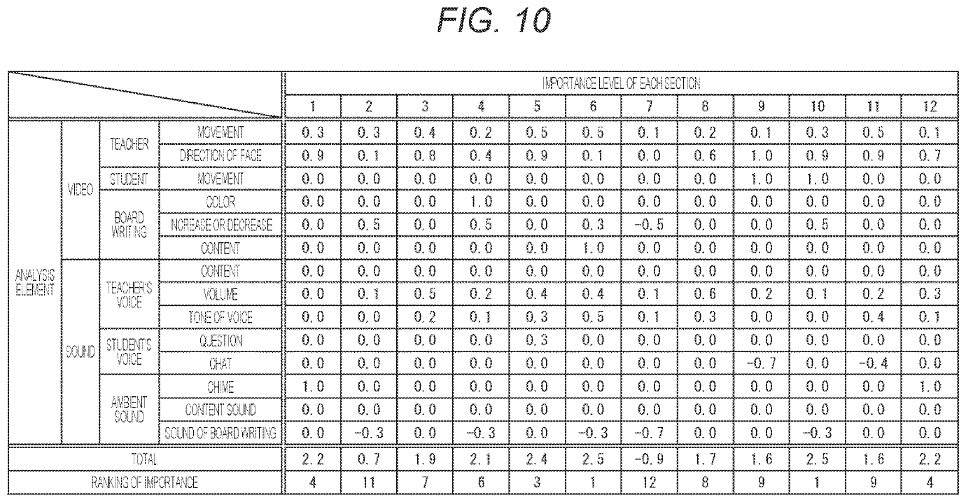

FIG. 10 is a diagram illustrating an example of the importance levels of respective pieces of the analysis information determined for each determination section.

As illustrated in FIG. 10, for each determination section, the importance levels are each determined with respect to one of the following: the direction of the teacher's face, the movement of the student, the color of the board writing, the increase or decrease in the volume of the board writing; the content of the board writing, the content of the teacher's voice, the volume of the teacher's voice, the tone of the teacher's voice, the question of the student's voice, the chat of the student's voice, the chime, the content sound, and the board writing sound.

For example, for the determination section 1, the importance levels are determined as follows: the importance level of the movement of the teacher is 0.3, the importance level of the direction of the teacher's face is 0.9, the importance level of the movement of the student is 0, the importance level of the color of the board writing is 0, the importance level of the increase or decrease in the board writing is 0, the importance level of the content of the board writing is 0, the importance level of the content of the teacher's voice is 0, the importance level of the volume of the teacher's voice is 0, the importance level of the tone of the teacher's voice is 0, the importance level of the question by the student's voice is 0, the importance level of the chat by the student's voice is 0, the importance level of the chime is 1.0, the importance level of the content sound is 0, and the importance level of the board writing sound is 0.

The importance levels of each of the determination sections 2 to 12 are also determined similarly.

As described above, the importance level determination unit 105 calculates, as the final importance level, the sum of the importance levels each determined for one of the pieces of analysis information in each determination section.

In the case of the example of FIG. 10, as illustrated in the lower part of FIG. 10, the final importance levels of the determination sections 1 to 12 are respectively obtained as 2.2, 0.7, 1.9, 2.1, 2.4, 2.5, −0.9, 1.7, 1.6, 2.5, 1.6, and 2.2. The ranking of the final importance levels is as follows: the first place is the determination sections 6 and 10, the third place is the determination section 5, the fourth place is the determination sections 1 and 12, the sixth place is the determination section 4, the seventh place is the determination section 3, the eighth place is the determination sect ion 8, the ninth place is the determination sections 9 and 11, the eleventh place is the determination section 2, and the twelfth place is the determination section 7.

The automatic editing execution unit 106 performs editing, depending on the final importance levels for the determination sections 1 to 12 and in accordance with the editing rules. Here, it is assumed that there is instructed, as the editing rules, a rule of “deleting is performed in ascending order of importance level so that the time of the lecture-containing video becomes ⅔ of the actual lecture time”.

In this case, if it is assumed that the importance levels are obtained as in FIG. 10, the automatic editing execution unit 106 performs editing by deleting four sections of the determination sections 7, 2, 9, and 11 among the determination sections 1 to 12 in ascending order of importance level.

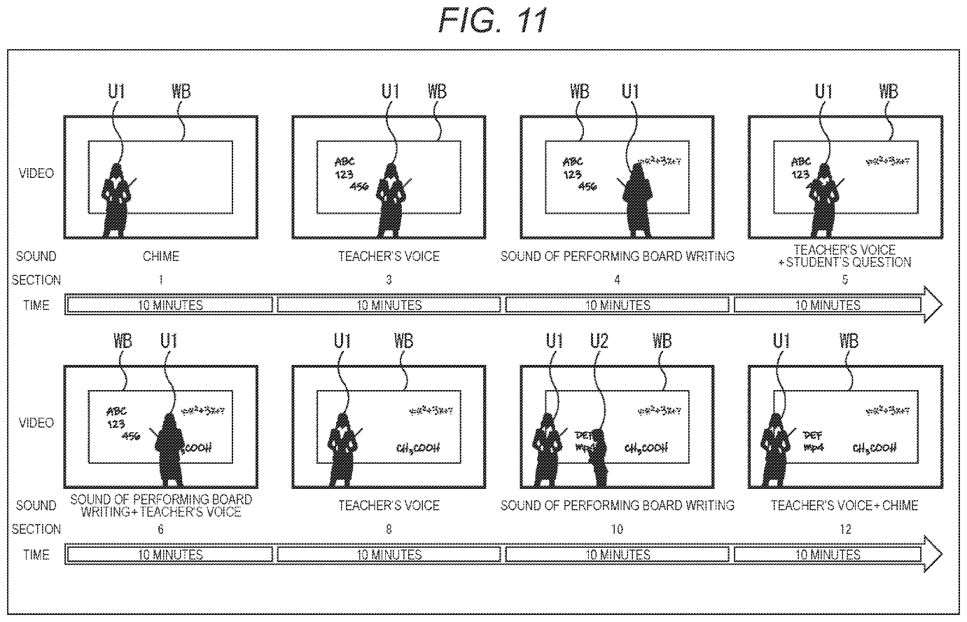

FIG. 11 is a diagram illustrating an example of a timeline of edited video data.

As illustrated in FIG. 11, the edited video data is the video data in which the determination section 1, the determination section 3, the determination section 4, the determination section 5, the determination section 6, the determination section 8, the determination section 10, and determination section 12 are combined.

Since the time of the actually given lecture is 120 minutes, the automatic editing execution unit 106 generates video data for 80 minutes, which is ⅔ of the actual lecture time.

The video data obtained by the above editing is output to the recording device 3 and the input/output device 4 by the video output unit 107. The video data obtained by the editing is recorded in the recording device 3 or presented to the user by the input/output device 4.

### 3. Operation of Arithmetic Device

Here, an operation of the arithmetic device 2 having the above configuration will be described.

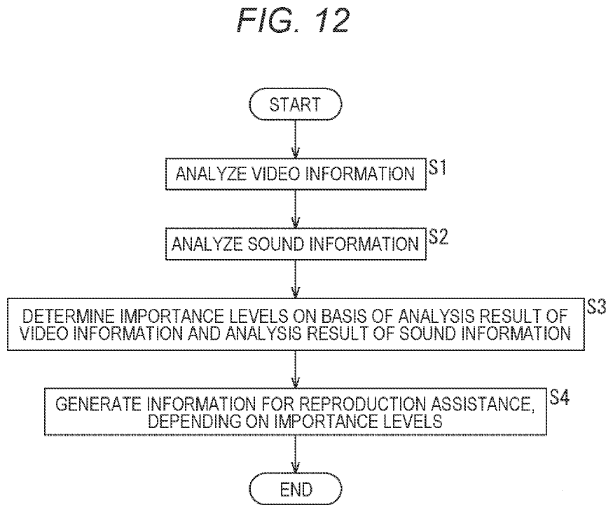

With reference to the flowchart of FIG. 12, a description will be given on a process to be performed by the arithmetic device 2.

The process of FIG. 12 is started, for example, when video data is input from the video capturing device 1 to the video input unit 101. In the video data, a video signal is output to the video analysis unit 102, and a sound signal is output to the sound analysis unit 103.

In step S1, the video analysis unit 102 analyzes video information on the basis of the video signal.

In step S2, the sound analysis unit 103 analyzes sound information on the basis of the sound signal. Note that a process in step S2 may be performed in parallel with the process in step S1, or may be performed after the process in step S1 is performed.

In step S3, the importance level determination unit 105 determines the importance level of each section obtained by dividing the video data on the basis of an analysis result of the video information by the video analysis unit 102 and an analysis result of the sound information by the sound analysis unit 103.

In step S4, the automatic editing execution unit 106 generates information for reproduction assistance, depending on the importance levels determined by the importance level determination unit 105. That is, the automatic editing execution unit 106 functions as a generation unit that generates information for reproduction assistance. The information for reproduction assistance is information used for providing a lecture-containing video to the user. The automatic editing execution unit 106 generates video data as the information for reproduction assistance by, for example, deleting video data of a section with a low importance level, and compressing a section with a low importance level at a compression ratio higher than compression ratios for other sections.

Note that the following information may be generated as the information for reproduction assistance: meta-information for editing depending on the importance levels; and meta-information for reproducing depending on the importance levels. Such pieces of meta-information will be described later.

After the information for reproduction assistance is generated, the process of FIG. 12 ends. The information for reproduction assistance is output to the recording device 3 and the input/output device 4 by the video output unit 107, and is used to provide the lecture-containing video to the user. For example, the input/output device 4 displays the lecture-containing video obtained by reproducing the video data serving as the information for reproduction assistance, thereby providing the lecture-containing video to the user.

As described above, in the arithmetic device 2, the video data is edited depending on the importance level determined for each section of the video data on the basis of the analysis information with respect to the information associated with the lecture. The information associated with the lecture includes, for example, information regarding a teacher and a student, and information regarding a board writing, a chime, a material attached to a whiteboard, and a moving image material.

In a case where the technology described in Patent Document 1 is applied to editing of a lecture-containing video, importance level determination is performed on the basis of information linked to a person in a case where a lecture-containing video is edited depending on the importance level determined as described above, the importance level of a section of the video in which the teacher is performing board writing is low; therefore, there is a possibility that the information on the order in which the board writing was performed is lost from the lecture-containing video.

In addition, there is a possibility that the following case happens. The importance level of a section of the video in which a board writing written with a red color pen is imaged is determined to be low, even though such a video is supposed to be important; therefore, a section of the video in which the board writing written with a red color pen is imaged is lost from the lecture-containing video.

Since the arithmetic device 2 edits the video data, depending on the importance level of the analysis information regarding the information associated with the lecture, it is possible to edit the video data without missing information that is supposed to be important in recording of the lecture, such as the information regarding the order in which a board writing was performed and the information regarding a board writing written with a red color pen.

Therefore, the arithmetic device 2 can edit the lecture-containing video in an appropriate form. Furthermore, since the arithmetic device 2 performs editing while deleting the video data of a section not important in learning, or performs editing while compressing such video data at a higher compression ratio, it is possible to record the video data of a lecture-containing video whose data volume is reduced.

Since the user who views and listens to the lecture-containing video views and listens to the video in which a section chat is not important in learning is deleted, it is possible to learn the content of the lecture in a time shorter than the time of the actually given lecture.

### 4. Modified Example

Information Associated with Lecture

Although an example has been described in which an importance level is determined on the basis of the analysis information about information regarding a board writing performed on the board surface of a whiteboard, the importance level may be determined on the basis of the analysis information regarding information regarding a screen on which a presentation material is projected.

In this case, for example, the importance level is determined on the basis of the analysis information about switching of slides and animation. As described above, the present technology can be applied also to imaging a lecture using something other than board writing. In addition, the lecture may be imaged in a state in which the whiteboard and the screen are simultaneously present within the angle of view of the video capturing device 1.

The importance level may be determined on the basis of analysis information about information regarding a board writing performed on, instead of a whiteboard, a blackboard, a greenboard, or paper such as imitation Japanese vellum.

A sound collection device different from a sound collection device mounted on the video capturing device 1 may be used to collect sound regarding a lecture. For example, it is possible to collect a voice uttered by a teacher with a pin microphone worn by the teacher. In this case, the pin microphone is connected to the arithmetic device 2 and outputs a sound signal representing the collected sound to the arithmetic device 2.
Information for Reproduction Assistance

The automatic editing execution unit 106 may generate meta-information for editing, depending on the importance levels as the information for reproduction assistance. For example, the meta-information representing the result of the importance level determination by the importance level determination unit 105 is generated by the automatic editing execution unit 106 as the meta-information for editing, depending on the importance levels.

In this case, the video output unit 107 outputs the video data supplied from the video capturing device 1 and the meta-information generated by the automatic editing execution unit 106 to the recording device 3 and the input/output device 4.

For example, in a case where a plurality of users wants to view and listen to the lecture-containing video at different lengths in accordance with their proficiency levels, the input/output device 4 edits the video data for each user, using the meta-information supplied from the arithmetic device 2, and reproduces the edited video data. In such a way, the video capturing device 1 can provide the lecture-containing video having a length in accordance with the proficiency level of each user.

Note that the editing of the video data in accordance with the proficiency level of each user may be performed as follows. The arithmetic device 2 edits the video data on the basis of the meta-information recorded in the recording device 3, in accordance with a rule signal representing editing rules for performing editing in accordance with the proficiency level of each user.

Alternatively, the automatic editing execution unit 106 may generate the meta-information for reproducing, depending on the importance levels as the information for reproduction assistance. For example, the meta-information representing the result of the importance level determination by the importance level determination unit 105 is generated by the automatic editing execution unit 106 as the meta-information for reproducing, depending on the importance levels.

In this case, the video output unit 107 outputs the video data supplied from the video capturing device 1 and the meta-information generated by the automatic editing execution unit 106 to the recording device 3 and the input/output device 4.

The input/output device 4 displays a reproduction position of a section with a high importance level on, for example, a seek bar on a view screen for viewing and listening to the lecture-containing video. In such a way, the user who views the lecture-containing video can select, for example, the reproduction position displayed on the seek bar on the view screen, and can easily cause the video of the section important in learning to be reproduced from the lecture-containing video. Note that, instead of the user selecting the reproduction position, the input/output device 4 may skip a section having a low importance level and may automatically reproduce only the reproduction position displayed on the seek bar because of its high importance level.

In addition, together with the information for reproduction assistance, thumbnail images representing respective ones of the sections for which the importance levels are determined may be produced by the automatic editing execution unit 106.

For example, the arithmetic device 2 performs importance level determination with respect to each of the frames constituting a certain section, and sets, as the thumbnail image, the frame image of the frame having the highest importance level. The frame image of the first or last frame of each section may be set as the thumbnail image.

The video output unit 107 outputs the information for reproduction assistance generated by the automatic editing execution unit 106 and the thumbnail images of respective ones of the sections of the lecture-containing video to the recording device 3 and the input/output device 4.

In a case where the thumbnail image is supplied to the input/output device 4 together with the meta-information for reproducing depending on the importance levels, the input/output device 4 displays, on the seek bar on the view screen, the reproduction position of the section with a high importance level and, in addition, the thumbnail image of such a section. In such a way, the input/output device 4 can present clearer information to the user who views and listen to the lecture-containing video.
Analysis Information

The types of analysis information analyzed by the video analysis unit 102 and the sound analysis unit 103 can also be set in advance, or can be instructed by the user by a rule signal entered via the input/output device 4. For example, in a case where a real-time property is considered to be important for the user, it is instructed that necessary and sufficient analysis information should be analyzed.
Method of Importance Level Determination

The importance level determination may be performed in accordance with a frequency of appearance of each element supposed to be analysis information in the video obtained by imaging by the video capturing device 1.

For example, in a case where an appearance frequency of a board writing written with a red color pen is high and an appearance frequency of the board writing written with a black color pen is low, the importance level determination unit 105 determines that the characters written with a black color pen are characters written for emphasis and therefore determines that the importance level of the section in which the lecturer is performing board writing with a black color pen has a high value.

In a case where most of the board writing is performed with a red color pen, if the importance level is determined only in accordance with, for example, an importance level determination rule such as “If a board writing is performed using a red pen, the importance level is high”, a large number of sections are determined to have high importance levels.

However, in a case where most of the board writing is performed with a red color pen, if the importance level determination unit 105 performs the importance level determination in accordance with the appearance frequencies of the board writing written with a red color pen and the board writing written with a black color pen, it is possible to perform the importance level determination reflecting the teacher's intention, for example, to write important characters with a black color pen.

In addition, for example, in a case where the same formula repeatedly appears in a board writing, the importance level determination unit 105 determines that the repeatedly appearing formula is an important formula in learning, and therefore determines that the importance level of the section in which the repeatedly appearing formula is written is a high value. It is also possible to determine that the importance level of the section including the timing at which the repeatedly appearing formula is first written is a particularly high value.

The importance level may be determined on the basis of a temporal change in each piece of analysis information. For example, the importance level determination may be performed on the basis of the temporal change in a board writing amount.

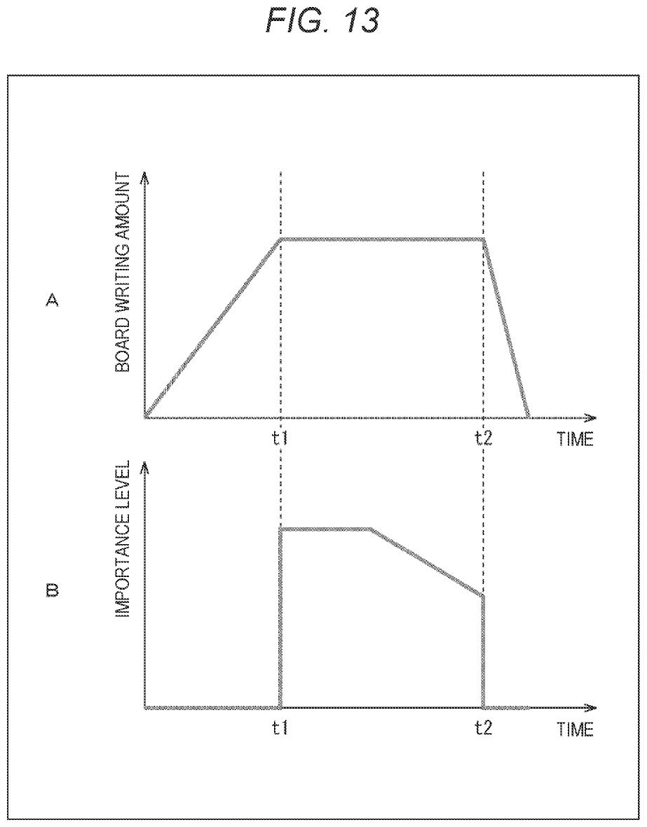

FIG. 13 is a diagram illustrating the relationship between a temporal change in a board writing amount and an importance level.

A of FIG. 13 illustrates an example of the temporal change in the board writing amount. In A of FIG. 13, the horizontal axis represents time, and the vertical axis represents board writing amount.

As illustrated in A of FIG. 13, the board writing amount increases (the board writing is being performed) in the period up to time t1. The increase in the board writing amount stops at time t1 (the board writing is completed), and the board writing amount does not change in the period from time t1 to time t2 (an explanation is continuing without board writing). After time t2, the board writing amount decreases (the board writing is being erased).

B of FIG. 13 illustrates an example of the importance level determined in accordance with the temporal change in the board writing amount. In B of FIG. 13, the horizontal axis represents time and the vertical axis represents importance level.

As illustrated in B of FIG. 13, the importance level is low in the period up to time t1 in which the board writing amount is increasing. At the timing of time t1 at which the board writing amount stops increasing, the importance level becomes high. In the period from time t1 to time t2 in which the board writing amount does not change, the importance level gradually decreases from the timing until which the board writing amount does not change continuously for a certain period of time. At the timing of time t2 at which The board writing amount starts to decrease, the importance level becomes low.

In such a manner, the importance level determination unit 105 determines the importance level of the increase or decrease in the board writing amount as the value, illustrated in B of FIG. 13 in accordance with the temporal change in board writing amount as illustrated in A of FIG. 13.

As described above, the importance level determination unit 105 determines the importance levels of each section of the video data, depending on the information regarding the board writing based on the video and the sound. The information regarding the board writing is, for example, information representing the state of the board writing or information representing the content of the board writing. The information representing the state of the board writing includes information representing an increase or decrease amount (temporal change) in the board writing, a position of a pen tip, a board writing sound, a color of the board writing, an appearance frequency of the color of the board writing, and the like. The information representing the content of the board writing includes information representing characters and a formula of the board writing and appearance frequencies of the characters and the formula.
Editing Method

When the ranking of the final importance level of each section is determined, in a case where there is a plurality of sections with final importance levels are the same, the ranking of such plurality of sections may be determined by using random numbers or may be determined in accordance with their order on the timeline.

In addition, in a case where there is a plurality of sections with the same final importance levels, the order of such plurality of sections may be determined on the basis of the importance levels obtained by referring to the importance levels of their respective preceding and succeeding adjacent sections.

In the case of the example of FIG. 10, the final importance levels of the determination section 9 and the determination section 11 are the same, and the final priority levels are also the same. For example, in a case where the automatic editing execution unit 106 edits to delete either the determination section 9 or the determination section 11, the automatic editing execution unit 106 compares the sums the sum (1.7+2.5=4.2) of the importance levels of the determination section 8 and the determination section 10, which are the preceding and succeeding determination sections of the determination. section 9, and the sum (2.5+2.2=4.7) of the importance levels of the determination section 10 and the determination section 12, which are the preceding and succeeding determination sections of the determination section 11.

By comparing the sum of the importance levels of the preceding and succeeding determination sections of the determination section 9 and the sum of the importance levels of the preceding and succeeding determination sections of the determination section 11, the automatic editing execution unit 106 performs editing to delete the determination section 9, the sum of the importance levels of the preceding and succeeding determination sections of which is smaller.

### 5. Computer

The above-described series of processes can be executed by hardware or software. In a case where the series of processes are executed by software, a program constituting the software is installed from a program recording medium to a computer incorporated in dedicated hardware, a general-purpose personal computer, or the like.

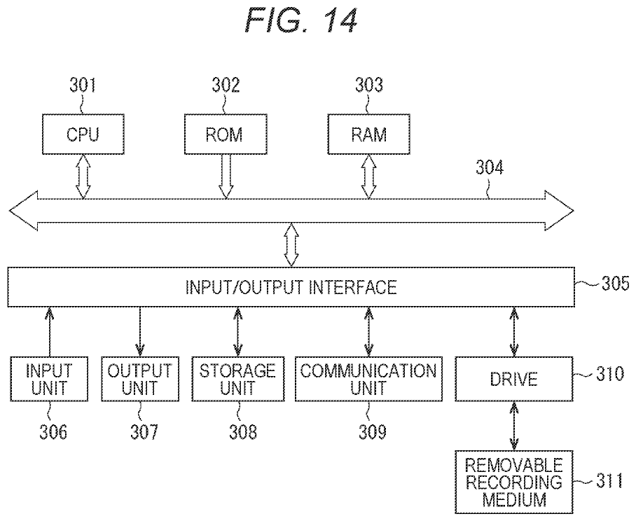

FIG. 14 is a block diagram illustrating a configuration example of hardware of a computer that executes the above-described series of processes by a program.

A central processing unit (CPU) 301, a read only memory (ROM) 302, and a random access memory (RAM) 303 are mutually connected by a bus 304.

To the bus 304, there is further connected an input/output interface 305. To the input/output interface 305 there are connected an input unit 306 including a keyboard, a mouse, and the like and an output unit 307 including a display, a speaker, and the like. Furthermore, to the input/output interface 305 there are connected a storage unit 308 including a hard disk, a nonvolatile memory, and the like, a communication unit 309 including a network interface and the like, and a drive 310 that drives a removable medium 311.

In the computer configured as described above, for example, the CPU 301 loads a program stored in the storage unit 308 into the RAM 303 via the input/output interface 305 and the bus 304, and executes the program, whereby the above-described series of processes are performed.

The program to be executed by the CPU 301 is provided, for example, by being recorded in the removable medium 311 or via a wired or wireless transmission medium such as a local area network, the Internet, or digital broadcasting, and is installed in the storage unit 308.

Note that the program to be executed by the computer may be a program in which processes are performed in time series in the order described in the present specification, or may be a program in which processes are performed in parallel or at a necessary timing, for example, when called.

Note that, in the present specification, a system means an aggregation of a plurality of constituent elements (devices, modules (parts), and the like), and it does not matter whether or not all the constituent elements are enclosed in the same housing. Therefore, any of the following is a system: a plurality of devices housed in separate housings and connected via a network, and one device in which a plurality of modules is housed in one housing.

The effects described in the present specification are merely examples and are not limited thereto, and other effects may be provided.

Embodiments of the present technology are not limited to the above-described embodiment, and various modifications can be made without departing from the gist of the present technology.

For example, the present technology can have a configuration of cloud computing in which one function is shared and processed in cooperation by a plurality of devices via a network.

Furthermore, each step described in the above-described flowchart is executed by one device, but can also be executed by a plurality of devices.

Furthermore, in a case where a plurality of processes is included in one step, the plurality of processes included in the one step can be not only executed by one device but also shared and executed by a plurality of devices.

### Examples of Combination of Configurations

The present technology can also have the following configurations.

(1)

An information processing device including:

a generation unit configured to generate information for reproduction assistance, depending on importance levels each determined for one of predetermined sections generated by dividing data including a video and a sound of a lecture, the importance levels being determined on the basis of information associated with the lecture.

(2)

The information processing device according to above item (1), in which

the information associated with the lecture is information regarding a board writing based on the video or the sound.

(3)

The information processing device according to above item (2), in which

the information regarding the board writing is information representing a state of the board writing or a content of the board writing.

(4)

The information processing device according to above item (3), in which

the information regarding the board writing is information representing at least any one of a color of the board writing, an increase or a decrease in the board writing, or a formula contained in the board writing.

(5)

The information processing device according to any one of above items (1) to (4), in which

the information associated with the lecture is information representing an action of at least either one of a lecturer or an auditor of the lecture imaged is the video.

(6)

The information processing device according to any one of above items (1) to (5), in which

the information associated with the lecture is information representing a sound regarding the lecture.

(7)

The information processing device according to any one of above items (1) to (6), in which

by editing the data depending on the importance levels, the generation unit generates edited data as the information for reproduction assistance.

(8)

The information processing device according to above item (7), in which

the generation unit generates the edited data by deleting the data of a section with a low importance level or by compressing, at a compression ratio higher than other sections, the data of a section with a low importance level.

(9)

The information processing device according to any one of above items (1) to (6), in which

the generation unit generates, as the information for reproduction assistance, meta-information for performing editing, depending on the importance levels.

(10)

The information processing device according to any one of above items (1) to (6), in which

the generation unit generates, as the information for reproduction assistance, meta-information for performing reproduction, depending on the importance levels.

(11)

The information processing device according to any one of above items (1) to (10), further including

a determination unit configured to determine the importance level for each of the predetermined sections on the basis of the information associated with the lecture,

in which the generation unit generates the information for reproduction assistance, depending on the importance levels determined by the determination unit.

(12)

The information processing device according to above item (11), in which

the determination unit determines importance levels each for one of determination sections into each of which a plurality of consecutive sections are combined, and

the generation unit generates the information for reproduction assistance, depending on the importance levels each determined, for one of the determination sections, by the determination unit.

(13)

The information processing device according to above item (12), in which

the determination unit determines the importance level for each of the determination sections into each of which a previously set number of the sections are combined.

(14)

The information processing device according to above item (12), in which

the determination unit determines the importance level for each of the determination sections set on the basis of the information associated with the lecture

(15)

The information processing device according to any one of above items (1) to (14), in which

the generation unit generates, together with the information for reproduction assistance, thumbnail images each representing one of the sections.

(16)

The information processing device according to any one of above items (1) to (15), in which

for the sections having the same importance level, the generation unit generates the information for reproduction assistance, depending on the importance levels for a preceding section and a succeeding section of each of the sections having the same importance level.

(17)

The information processing device according to above item (11), in which

the determination unit determines the importance level in accordance with a determination rule instructed by a user via an input device configured to accept an operation of the user.

(18)

The information processing device according to any one of above items (1) to (17), in which

the generation unit generates the information for reproduction assistance in accordance with an editing rule instructed by a user via an input device configured to accept an operation of the user.

(19)

A generation method including:

generating information for reproduction assistance, depending on importance levels each determined for one of predetermined sections generated by dividing data including a video and a sound of a lecture, the importance levels being determined on the basis of information associated with the lecture.

(20)

A program for causing a computer to perform a process including:

generating information for reproduction assistance, depending on importance levels each determined for one of predetermined sections generated by dividing data including a video and a sound of a lecture, the importance levels being determined on the basis of information associated with the lecture.

### REFERENCE SIGNS LIST

1 Video capturing device
2 Arithmetic device
3 Recording device
4 Input/output device
101 Video input unit
102 Video analysis unit
103 Sound analysis unit
104 Control parameter input unit
105 Importance level determination unit
106 Automatic editing execution unit
107 Video output unit

1. An information processing device comprising:
a generation unit configured to generate information for reproduction assistance, depending on importance levels each determined for one of predetermined sections generated by dividing data including a video and a sound of a lecture, the importance levels being determined on a basis of information associated with the lecture.

2. The information processing device according to claim 1, wherein
the information associated with the lecture is information regarding a board writing based on the video or the sound.

3. The information processing device according to claim 2, wherein
the information regarding the board writing is information representing a state of the board writing or a content of the board writing.

4. The information processing device according to claim 3, wherein
the information regarding the board writing is information representing at least any one of a color of the board writing, an increase or a decrease in the board writing, or a formula contained in the board writing.

5. The information processing device according to claim 1, wherein
the information associated with the lecture is information representing an action of at least either one of a lecturer or an auditor of the lecture imaged in the video.

6. The information processing device according to claim 1, wherein
the information associated with the lecture is information representing a sound regarding the lecture.

7. The information processing device according to claim 1, wherein
by editing the data depending on the importance levels, the generation unit generates edited data as the information for reproduction assistance.

8. The information processing device according to claim 7, wherein
the generation unit generates the edited data by deleting the data of a section with a low importance level or by compressing, at a compression ratio higher than other sections, the data of a section with a low importance level.

9. The information processing device according to claim 1, wherein
the generation unit generates, as the information for reproduction assistance, meta-information for performing editing, depending on the importance levels.

10. The information processing device according to claim 1, wherein
the generation unit generates, as the information for reproduction assistance, meta-information for performing reproduction, depending on the importance levels.

11. The information processing device according to claim 1, further comprising
a determination unit configured to determine the importance level for each of the predetermined sections on a basis of the information associated with the lecture,
wherein the generation unit generates the information for reproduction assistance, depending on the importance levels determined by the determination unit.

12. The information processing device according to claim 11, wherein
the determination unit determines importance levels each for one of determination sections into each of which a plurality of consecutive sections are combined, and
the generation unit generates the information for reproduction assistance, depending on the importance levels each determined, for one of the determination sections, by the determination unit.

13. The information processing device according to claim 12, wherein
The determination unit determines the importance level for each of the determination sections into each of which a previously set number of the sections are combined.

14. The information processing device according to claim 12, wherein
the determination unit determines the importance level for each of the determination sections set on a basis of the information associated with the lecture.

15. The information processing device according to claim 1, wherein
the generation unit generates, together with the information for reproduction assistance, thumbnail images each representing one of the sections.

16. The information processing device according to claim 1, wherein
for the sections having the same importance level, the generation unit generates the information for reproduction assistance, depending on the importance levels for a preceding section and a succeeding section of each of the sections having the same importance level.

17. The information processing device according to claim 11, wherein
the determination unit determines the importance level in accordance with a determination rule instructed by a user via an input device configured to accept an operation of the user.

18. The information processing device according to claim 1, wherein
the generation unit generates the information for reproduction assistance in accordance with an editing rule instructed by a user via an input device configured to accept as operation of the user.

19. A generation method comprising:
generating information for reproduction assistance, depending on importance levels each determined for one of predetermined sections generated by dividing data including a video and a sound of a lecture, the importance levels being determined on a basis of information associated with the lecture.

20. A program for causing a computer to perform a process comprising:
generating information for reproduction assistance, depending on importance levels each determined for one of predetermined sections generated by dividing data including a video and a sound of a lecture, the importance levels being determined on a basis of information associated with the lecture.
